(19) United States
(12) Patent Application Publication
(10) Pub. No.: US 2013/0238942 A1
(43) Pub. Date: Sep. 12, 2013

(54) PORT TEST DEVICE FOR MOTHERBOARDS

(71) Applicants: HONG FU JIN PRECISION INDUSTRY (ShenZhen) CO., LTD., (US); HON HAI PRECISION INDUSTRY CO., LTD., New Taipei (TW)

(72) Inventors: BO YANG, Shenzhen (CN); YOU-LIANG MA, Shenzhen (CN); TAI-CHEN WANG, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/775,108

(22) Filed: Feb. 22, 2013

(30) Foreign Application Priority Data
Mar. 12, 2012 (CN) 201220089977.1

(51) Int. Cl. G06F 11/07

(52) U.S. Cl. CPC G06F 11/0745
USPC 714/43

(57) ABSTRACT

A port test device for a motherboard includes a conversion member and a test apparatus. The motherboard comprising a serial attached small computer system interface (SAS) port and a serial advanced technology attachment (SATA) port. The conversion member includes a SAS connector and a SATA connector, the SATA connector is coupled to the SATA port, and is electronically connected to the SAS port. The test apparatus is selectively coupled to the SAS port or the SAS connector.

### BACKGROUND

1. Technical field

The disclosure generally relates to test devices, and particularly to a port test device for motherboards.

2. Description of the Related Art

Electronic devices, such as servers, often employ a motherboard including a serial attached small computer system interface (SAS) port, and a serial advanced technology attachment (SATA) port. Since the physical structures of the SAS port and the SATA port are different, it is very inconvenient for operators to have to use two different test devices to respectively test performances of the SAS port and the SATA port. Additionally, errors in testing may occur because of different test criterions of the two different test devices.

Therefore, there is room for improvement within the art.

### BRIEF DESCRIPTION OF THE DRAWINGS

Many aspects of an exemplary connection assembly and electronic device employing same can be better understood with reference to the following drawings. The components in the drawings are not necessarily drawn to scale, the emphasis instead being placed upon clearly illustrating the principles of the present embodiment.

FIG. 1 is block diagram illustrating a port test device for a motherboard, according to an exemplary embodiment.

FIG. 2 is a schematic view of the motherboard as shown in FIG. 1.

FIG. 3 is a circuit view of a conversion member of the port test device of FIG. 1.

### DETAILED DESCRIPTION

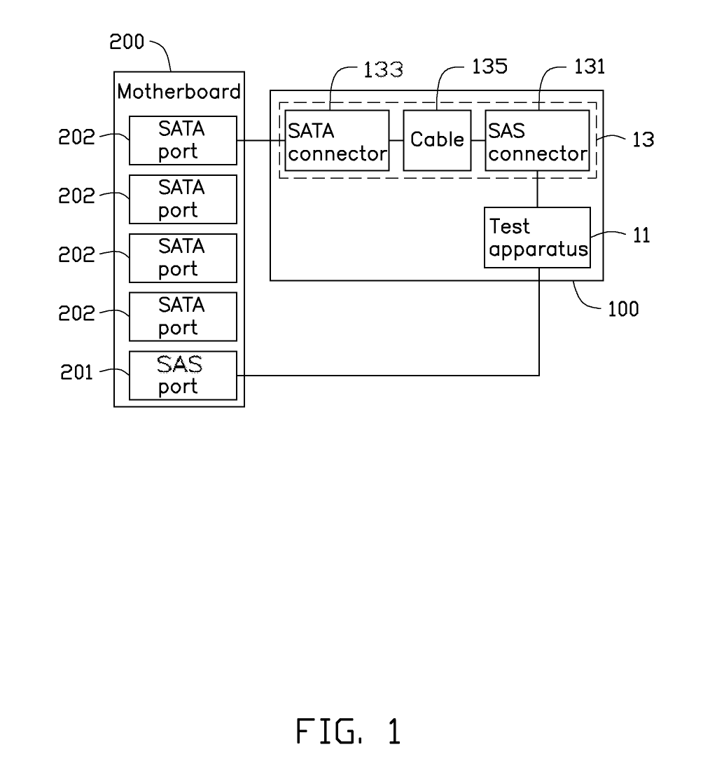

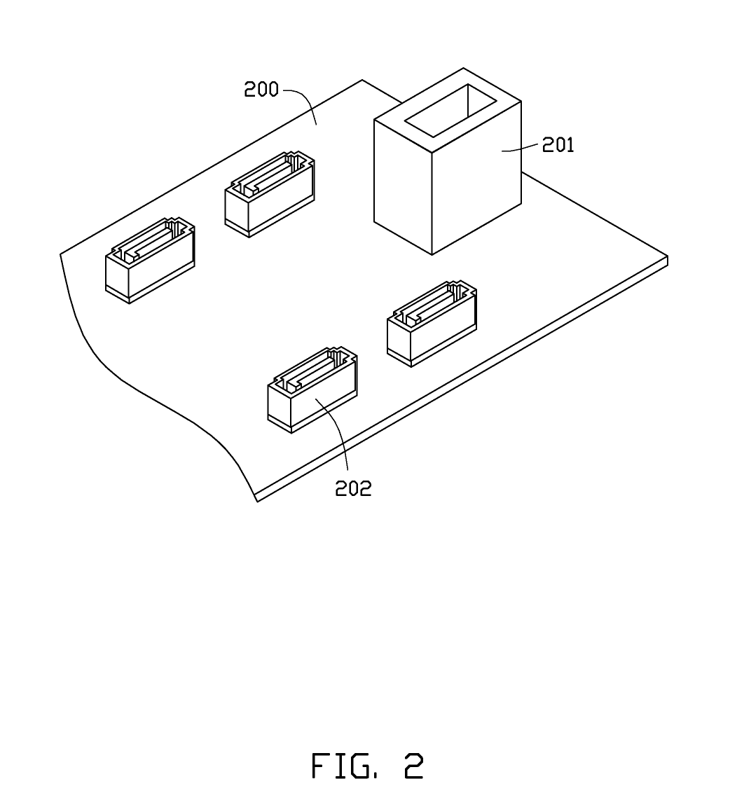

FIGS. 1-2 show a port test device 100, according to an exemplary embodiment. The port test device 100 can be used in an electronic device (not shown), such as a server, for example.

The electronic device includes a motherboard 200. The motherboard 200 includes a serial attached small computer system interface (SAS) port 201 and a plurality of serial advanced technology attachment (SATA) ports 202. The SAS port 201 and the plurality of SATA ports 202 are all configured to output SAS signals. The port test device 100 is used to test the SAS port 201 and the plurality of SATA ports 202, to determine whether performances of the SAS port 201 and the SATA port 202 are met a first predetermined common criterion and a second predetermined common criterion, respectively.

The port test device 100 includes a conversion member 13 and a test apparatus 15. The conversion member 13 includes a SAS connector 131, a SATA connector 133, and a cable 135 connected between the SAS connector 131 and the SATA connector 133. The SAS connector 131 is configured to couple to the test apparatus 15, and the SATA connector 133 is configured to couple to the SATA port 202 to receive the SAS signals output from the SATA port 202.

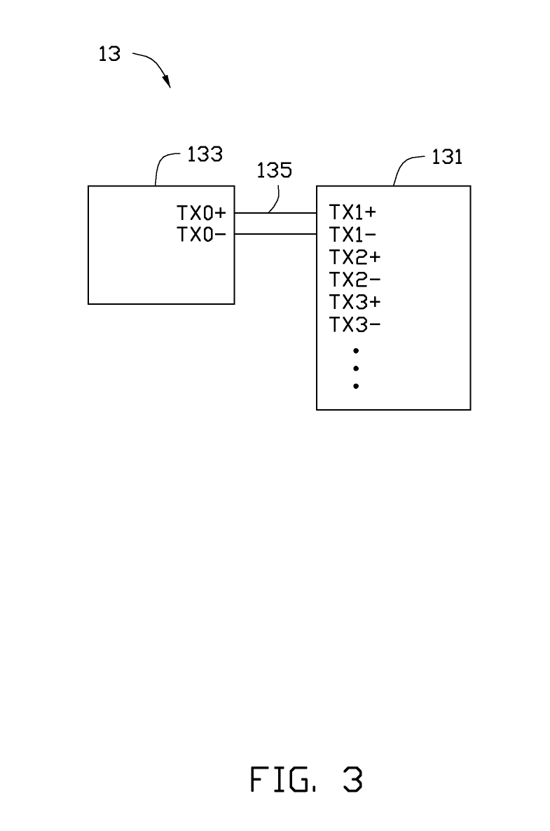

Referring to FIG. 3, the SAS connector 131 includes a plurality group of signal transmission pins TX1+, TX1−, TX2+, TX2−, TX3+, TX3−, . . . etc. The SATA connector 133 includes a group of signal connection pins TX0+, and TX0−. In one exemplary embodiment, the signal connection pins TX0+, and TX0− are respectively and electronically connected to the signal transmission pins TX1+, and TX1− via the cable 135. Thus, the SAS signals output from the SATA port 202 can be transmitted to the SAS connector 131 via the SATA connector 133 and the cable 135.

The test apparatus 15 can be electronically connected to the SAS port 201 or the SAS connector 131 to receive the SAS signals output from the motherboard 200. The test apparatus 15 analyzes the SAS signals, and accordingly determines whether the performances of the SAS port 201 meets the first predetermined common criterion, or accordingly determines whether the performances of the SATA port 202 meets the second predetermined common criterion.

To test the performance of the SAS port 201, the test apparatus 15 is directly and electronically connected to the SAS port 201 to receive the SAS signals. Thus, the performances of the SAS port 201 can be determined by the test apparatus 15.

To test the performance of the SATA port 202, the SATA connector 133 of the conversion member 13 is coupled to the SATA port 202, and the test apparatus 15 is electronically connected to the SAS connector 131. Then, the test apparatus 15 receives the SAS signals from the motherboard 200 via the SATA port 202 and the conversion member 13. Thus, the performances of the SATA port 202 can be determined by the test apparatus 15.

In summary, the port test device 100 can test both of the SAS port 201 and the SATA port 202 of the motherboard 200 through the conversion member 13 and the test apparatus 15. Thus, an extra port test device is not needed, this is very convenient for operators. Additionally, test accuracy may be improved because of a sole test criterion for the SAS signals.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A port test device for a motherboard, the motherboard comprising a serial attached small computer system interface (SAS) port and a serial advanced technology attachment (SATA) port, the port test device comprising:
a conversion member comprising a SAS connector and a SATA connector, the SATA connector coupled to the SATA port, and electronically connected to the SAS port; and
a test apparatus configured to couple to the SAS port or the SAS connector.

2. The port test device as claimed in claim 1, wherein the conversion member further includes a cable that is electronically connected between the SAS connector and the SATA connector.

3. The port test device as claimed in claim 2, wherein SAS connector includes a plurality group of signal transmission pins, the SATA connector includes a group of signal connection pins, and the group of signal connection pins are respectively and electronically connected to one group of signal transmission pins via the cable.

4. The port test device as claimed in claim 1, wherein the test apparatus tests SAS signals output from the SAS port or the SATA port of the motherboard.

5. The port test device as claimed in claim 1, wherein if the SAS port is tested, the test apparatus is coupled to the SAS port.

6. The port test device as claimed in claim 1, wherein if the SATA port is tested, the test apparatus is coupled to the SAS connector.

7. A port test device for a motherboard, the motherboard comprising a serial attached small computer system interface (SAS) port and a serial advanced technology attachment (SATA) port, the port test device comprising:
a test apparatus; and
a conversion member comprising a SAS connector and a SATA connector, the SATA connector coupled to the SATA port, and electronically connected to the SAS port;
wherein manipulation of the test apparatus causes the test apparatus to be electronically connected to the SAS port, the test apparatus receives SAS signals output from the SAS port; and
wherein manipulation of the test apparatus causes the test apparatus to be electronically connected to the SAS connector, the test apparatus receives SAS signals output from the SATA port via the conversion member.

8. The port test device as claimed in claim 7, wherein the conversion member further includes a cable that is electronically connected between the SAS connector and the SATA connector.

9. The port test device as claimed in claim 8, wherein SAS connector includes a plurality group of signal transmission pins, the SATA connector includes a group of signal connection pins, and the group of signal connection pins are respectively and electronically connected to one group of signal transmission pins via the cable.
